(19) United States
(12) Patent Application Publication
(10) Pub. No.: US 2026/0088686 A1
(43) Pub. Date: Mar. 26, 2026

(54) GROUNDING BRUSH ASSEMBLY

(71) Applicant: AKTIEBOLAGET SKF, GOTEBORG (SE)

(72) Inventors: Thomas PERROTIN, Saint Roch (FR); Emmanuel BENEVISE, Monts (FR)

(21) Appl. No.: 19/331,047

(22) Filed: Sep. 17, 2025

(30) Foreign Application Priority Data
Sep. 25, 2024 (FR) 2410220

(51) Int. Cl. H02K 11/40; H01R 39/24

(52) U.S. Cl. CPC H02K 11/40; H01R 39/24

(57) ABSTRACT

The grounding brush assembly includes a grounding brush provided with a plurality of conductive fibers and a holder inside which the conductive fibers are mounted, and a brush mounting plate rigidly connected to the holder. The holder and the conductive fibers each extend helically, the holder being provided with a first end and a second end that define the circumferential dimension of the holder and are axially offset relative to each other.

### CROSS-REFERENCE

This application claims priority to French patent application no. 2410220 filed on September 25, 2024, the contents of which are fully incorporated herein by reference.

### BACKGROUND OF THE INVENTION

The present invention relates to electrical grounding devices, and more particularly to grounding devices controlling the shaft current generated in motors or electric machines, preferably grounding brush assemblies.

In a motor or electric machine, at least one roller bearing is mounted between the housing of the motor or electric machine and the rotary shaft in order to support the shaft.

During operation, when the shaft is rotating, an electric potential difference can occur between the shaft and the housing of the motor or electric machine, which generates an electric current between the inner ring of the roller bearing, which is rigidly connected to the shaft, and the outer ring rigidly connected to the housing.

The electric current passing through the components of the roller bearing can damage the components, in particular the rolling elements and the raceways formed on the inner and outer rings. The electric discharges can also generate vibrations.

In order to overcome these drawbacks, it is known practice to earth or ground the rotary shaft using a grounding brush comprising conductive fibers. The grounding brush is generally mounted in the orifice of the housing of the electric motor so that the free ends of the fibers are in radial contact with the outer surface of the rotary shaft.

Due to the conductivity of the fibers, the brush is maintained at the same electric potential as the housing of the electric motor. The inner and outer rings of the roller bearing are also at the same electric potential, which reduces or even eliminates the problematic electric discharges through the roller bearing.

During the operation of the electric machine, the brushing of the conductive fibers of the brush on the outer surface of the rotary shaft causes wear and an increase in friction torque.

One known solution for limiting these effects is to reduce the thickness of the conductive fibers of the brush. This is however detrimental to the electrical performance of the brush assembly.

### SUMMARY OF THE INVENTION

The present invention aims to overcome the drawback discussed above.

To this end, the present invention proposes a grounding brush assembly comprising a grounding brush provided with a plurality of conductive fibers and a holder inside which the conductive fibers are mounted. The assembly further comprises a brush mounting plate that is rigidly connected to the holder of the brush.

The holder and the conductive fibers of the brush each extend helically, the holder being provided with a first end and a second end opposite the first end, which first end and second end define the circumferential dimension of the holder and are axially offset relative to each other.

Such a grounding assembly is intended to be mounted radially between a rotary shaft and a housing of an electric motor, the brush surrounding the rotary shaft with its conductive fibers in contact with the outer cylindrical surface of the rotary shaft. As the holder gives the brush its general shape, the brush is also helical.

During the operation of the electric machine, the outer cylindrical surface of the rotary shaft will thus be brushed by the brush in an axially larger zone than if the same brush extended entirely in the same plane (that is, if the brush was straight), while the instantaneous contact surface between the brush and the shaft will be substantially the same as if the brush was straight.

The wear of the shaft is thus reduced, while the electrical performance of the brush assembly is retained. In addition, when the shaft is lubricated with oil, the brush acts like an auger to drain any excess and thus limit the friction torque that such an excess can cause. The direction of the helical winding can in particular be adapted to the direction of rotation of the shaft in order to drain the oil in a predetermined direction, for example to move it away from a roller bearing in the vicinity of which the brush assembly is mounted.

According to one feature, the mounting plate comprises a radial portion and at least one centering portion that continues on at least axially from the radial portion, radially offset outwards relative to the holder and provided with an outer face defining the outer diameter of the mounting plate, and in which the radial portion of the mounting plate defines a through-opening, the holder of the brush extending through the opening.

Furthermore, the radial portion of the mounting plate is annular and extends radially between an inner edge defining the opening and an outer edge from which the centering portion extends, the holder of the brush at least partially bearing radially against the inner edge.

In addition, the radial portion of the mounting plate is provided with a first lateral face and a second lateral face on the opposite side from the first lateral face, which define the thickness of the radial portion, the first end of the holder of the brush bearing axially against the first lateral face and/or the second end of the holder of the brush bearing axially against the second lateral face.

Advantageously, the radial portion of the mounting plate locally has a protrusion extending radially inside the opening, the first end and/or the second end bearing axially against the locking protrusion.

In addition, with respect to the circumferential direction, the length of the protrusion of the radial portion of the mounting plate is greater than the gap between the first end and the second end of the holder of the brush.

According to another feature, the mounting plate comprises a plurality of members for retaining the holder of the brush.

Furthermore, some of the retaining members are formed on the first lateral face of the radial portion of the mounting plate and some of them are formed on the second lateral face of the radial portion of the mounting plate.

For example, the retaining members comprise centering tabs each having an axial arm and a radial arm continuing on from the axial arm radially and inwards, the holder bearing axially against at least some of the radial arms of the centering tabs and bearing radially against at least some of the axial arms of the centering tabs.

The invention further relates to an electric motor comprising a housing, a shaft, at least one bearing mounted radially between the housing and the shaft, and at least one grounding brush assembly as described above mounted radially between the housing and the shaft, the conductive fibers of the brush of the assembly being in contact with the shaft.

### BRIEF DESCRIPTION OF THE SEVERAL VIEWS OF THE DRAWINGS

Further aims, advantages and features will become apparent from the following description, given solely by way of illustration with reference to the appended drawings, in which:

FIG. 1 is an axial cross-sectional view of a grounding brush assembly mounted radially between a rotary shaft and a housing of an electric motor;

FIG. 2 is a perspective view of a grounding brush assembly according to one exemplary embodiment of the invention;

FIG. 3 is a perspective view of a grounding brush assembly according to one exemplary embodiment of the invention;

FIG. 4 is a front view of the grounding brush assembly in FIGS. 2 and 3;

FIG. 5 is a cross-sectional view along the line V-V in FIG. 4;

FIG. 6 is a detailed view of FIG. 5; and

FIG. 7 is a cross-sectional view along the line VII-VII in FIG. 4.

### DETAILED DESCRIPTION OF THE INVENTION

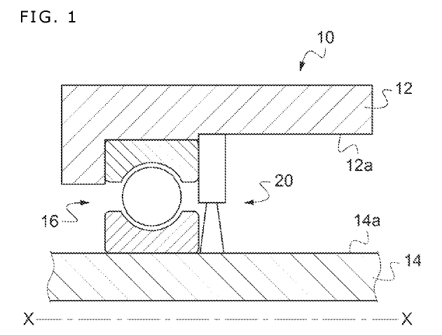

FIG. 1 shows an axial cross-section of a part of a motor 10 or electric machine comprising a fixed housing 12 and a rotary shaft 14 having an axis X-X, radially supported by a roller bearing 16. The bearing 16 is mounted radially between the housing 12 and the rotary shaft 14. Preferably, the bearing is a ball bearing. Alternatively, the bearing 16 may include any other appropriate rolling elements, such as cylindrical rollers, tapered rollers, needles, etc. or may even be formed as a plain bearing.

The motor 10 further comprises a grounding brush assembly 20 mounted radially between the orifice or bore 12a of the housing 12 and the outer cylindrical surface 14a of the rotary shaft 14.

The grounding brush assembly 20 makes it possible to continuously dissipate the electrical charges that accumulate on the shaft 14 of the motor during the operation of the motor by transferring them to the housing 12.

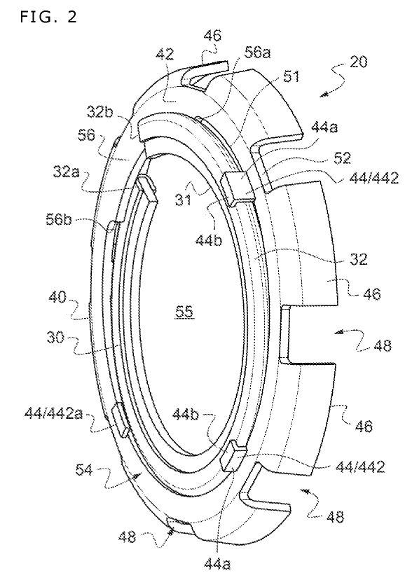

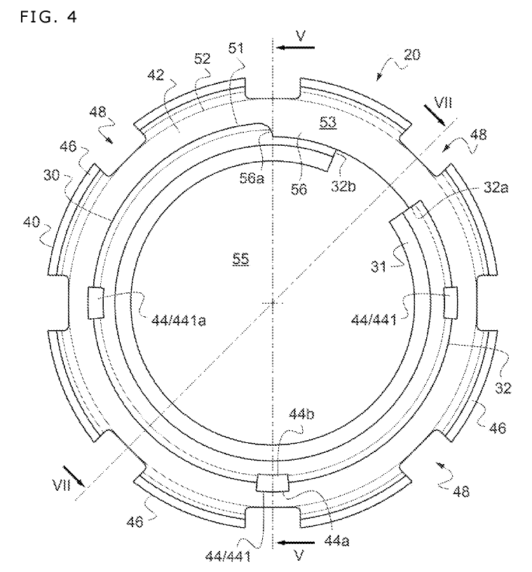

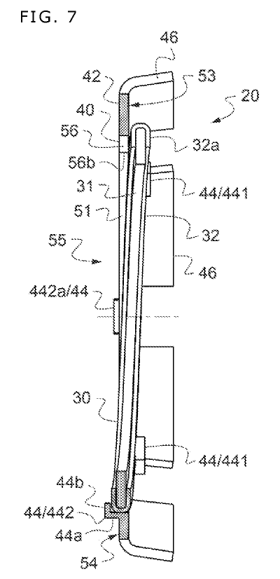

A grounding brush assembly 20, according to one exemplary embodiment of the invention, will now be described with reference to FIGS. 2 to 7.

The grounding brush assembly 20 has a generally annular shape and thus defines a through-opening 55 providing a passage for the rotary shaft 14. The assembly 20 basically comprises a grounding brush 30 and a brush mounting plate 40 configured to radially center the brush 30.

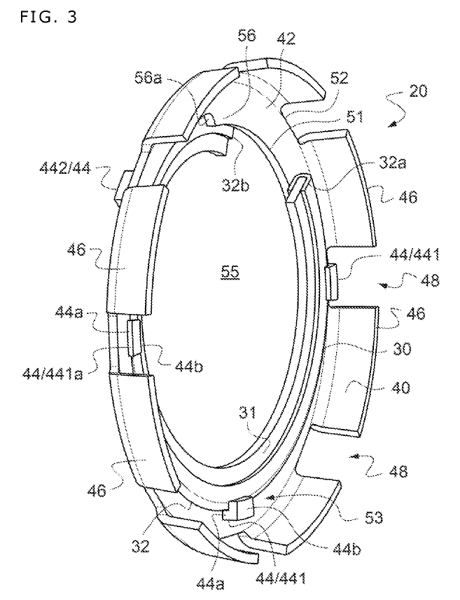

As can be seen in particular in FIGS. 2 and 3, the brush 30 has a helical shape in the circumferential direction. Preferably, the brush 30 also extends through the opening 55 and protrudes axially on each side of the opening 55. Alternatively, the brush 30 could extend entirely on one side or the other of the opening 55. As a further alternative, the brush 30 could extend within the opening 55 and only protrude on one side of the opening 55.

The brush 30 comprises a plurality of individual conductive fibers 31 intended to go around the rotary shaft 14 of the motor 10. The conductive fibers 31 can be made from carbon, stainless steel or conductive plastics, such as acrylic or nylon fibers.

The brush 30 further comprises a holding member or holder 32 inside of which the conductive fibers 31 are mounted or disposed. In the illustrated embodiment, the holder 32 is in the form of an open ring.

As can be seen in FIGS. 2 and 3, the holder 32 is rigidly connected to the mounting plate 40 so that it extends helically, in the circumferential direction, between a first end 32a and a second end 32b opposite to the first end 32a. The first and second ends 32a, 32b define the circumferential dimension of the holder. The first end 32a and the second end 32b are thus axially offset from each other. Furthermore, here, the holder 32 extends through the opening 55, so that the ends 32a and 32b are situated axially on either side of the opening 55. Alternatively, the holder 32 could extend entirely on one side or the other of the opening 55. As a further alternative, the holder 32 could extend through or be disposed within the opening 55 and only protrude on one side of the opening 55.

The holder 32 is preferably formed by cutting and stamping. The holder 32 is made from an electrically conductive material, such as for example aluminum, stainless steel, bronze, copper or another material. Alternatively, the holder 32 can be made from an electrically non-conductive material with a conductive coating or a conductive paint.

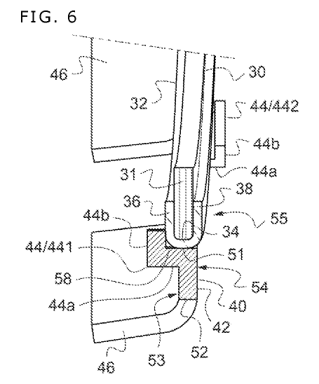

As illustrated more clearly in FIG. 6, the holder 32 comprises an axial mounting portion 34 and two opposite lateral walls 36, 38 extending inwardly from the mounting portion 34 and axially clasping the conductive fibers 31. The conductive fibers 31 bear axially on either side against the lateral walls 36, 38; more specifically, the conductive fibers 31 bear axially on either side against the inner faces of the lateral walls 36, 38.

The mounting portion 34 and the two lateral walls 36, 38 define a channel that is radially open on the inner side, and inside of which the conductive fibers 31 are partially situated or disposed.

The conductive fibers 31 can be bent around a connecting wire (not shown) of the holder 32. The free distal end of the conductive fibers 31 is intended to come into radial contact with the outer surface 14a of the rotary shaft 14 of the motor 10. The proximal end of the conductive fibers 31 is in radial contact with the mounting portion 34 of the holder.

Similarly to the holder 32, the conductive fibers 31 also extend helically. The lateral wall 36 of the holder 32 continues on from one end of the mounting portion 34 and the lateral wall 38 continues on from the opposite end thereof. The lateral walls 36, 38 extend inwardly substantially parallel to each other from the mounting portion 34. Alternatively, the lateral walls 36, 38 could extend inwardly obliquely from the mounting portion 34. The lateral walls 36, 38 are symmetrical with each other relative to a radial mid-plane of the holder 32. Preferably, the mounting portion 34 extends axially, but the mounting portion 34 may alternatively extend obliquely.

As indicated above, the brush 30 is in the form of an open ring, as can be seen in particular in FIGS. 2 to 4. This makes it possible to adapt the brush to different diameters of the shaft 14 of the motor 10. The ends of the brush 30 are not fastened to each other.

The mounting plate 40 comprises an annular radial portion 42 extending radially between an inner annular edge 51, or small diameter edge, and an outer annular edge 52, or large diameter edge, radially opposite the inner annular edge 51.

The inner annular edge 51 defines the central opening 55.

The radial portion 42 extends axially between a first lateral face 53 (FIG. 3) and a second lateral face 54 (FIG. 2), on the opposite side from the first lateral face 53. The lateral faces 53, 54 define the thickness of the radial portion 42.

The radial portion 42 has a radially wider portion forming a locking protrusion 56 on the inner side of the radial portion 42, that is, on the side on which the central opening 55 is located. The locking protrusion 56 extends radially to a free end 57. The locking protrusion 56 extends in the circumferential direction between a first end 56a and a second end 56b, opposite the first end 56a.

The mounting plate 40 further comprises a plurality of retaining members for retaining the brush 30, here formed on the radial portion 42. Preferably, these retaining members take the form of centering tabs 44 extending from the radial portion 42 of the mounting plate 40. Alternatively, the retaining members could be solder points between the holder 32 and the mounting plate 40.

Some of the tabs 44 are formed on the first lateral face 53 and a remainder of them are formed on the second lateral face 54. More specifically, the plurality of centering tabs 44 includes first centering tabs 441 extending from the first lateral face 53 and second centering tabs 442 extending from the second lateral face 54. The tabs 441 and 442 therefore extend in opposite axial directions.

The first tabs 441 and the second tabs 442 are preferably also positioned alternately in the circumferential direction; that is, each second tab 442 is situated or located, in the circumferential direction, between two successive first tabs 441.

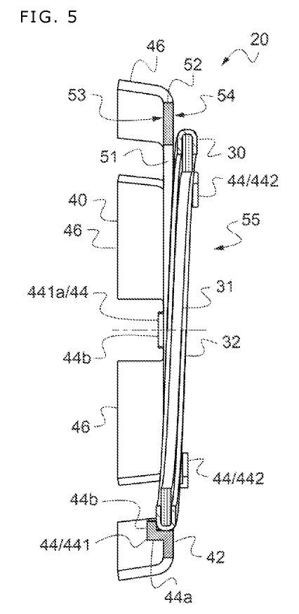

Each centering tab 44 is provided with an axial arm 44a extending axially from the radial portion 42 and a radial arm 44b continuing on from the axial arm 44a radially and inwardly, so that the centering tab 44 has an L-shaped profile. As can be seen in FIGS. 5 to 7, and more specifically in FIG. 6, the axial arm 44a has an inner face 58 that is oriented radially inwardly and flush with the inner edge 51, that is, the inner face 58 extends axially continuing on from the inner edge 51. The radial arm 44b extends facing the opening 55.

Generally, the tabs 44 and the radial portion 42 are configured to axially and radially retain the brush 30.

The brush 30 is positioned on the mounting plate 40 so that the holder 32, and more specifically its mounting portion 34, bears radially against the inner edge 51 of the radial portion 42 and against at least some of the inner faces 58 of the axial arms 44a.

Furthermore, the brush 30 is positioned on the mounting plate 40 so that at least one of the ends 32a and 32b of the holder 32 bears axially against the locking protrusion 56, while the rest of the holder 32 bears against at least some of the radial arms 44b of the centering tabs 44.

More specifically, as the ends 32a and 32b are situated axially on either side of the radial portion 42, the first end 32a bears axially against the first lateral face 53 and the second end 32b bears axially against the second lateral face 54.

Furthermore, as can be seen in FIG. 6, the lateral wall 36 of the holder 32 bears axially against the radial arms 44b of the first tabs 441, while the lateral wall 38 bears axially against the radial arms 44b of the second tabs 442.

Furthermore, in the circumferential direction, the length of the axial arm 44a of the first tabs 441 decreases progressively from one first tab 441 to the next, while the length of the axial arm 44a of the second tabs 442 increases progressively from one second tab 442 to the next. In other words, in the circumferential direction, the distance between the radial arm 44b of the first tabs 441 and the radial portion 42 decreases progressively from one first tab 441 to the next, while the distance between the radial arm 44b of the second tabs 442 and the radial portion 42 increases progressively from one second tab 442 to the next.

The tabs 44 and the radial portion 42 thus define between them a mounting path extending along a helical trajectory in which the holder 32 of the brush 30 is received and guided. More specifically, the path is defined axially on one side by the radial arms 44b of the first tabs 441 and axially on the opposite side by the radial arms 44b of the second tabs 442, while it is defined radially by the inner edge 51 and the axial arms 44a of the tabs 44. By guiding the holder 32, the path gives the holder 32, and therefore the brush 30, their helical shape.

It will be noted that among the first tabs 441 and among the second tabs 442 there is one tab 441a and one tab 442a respectively on which the length of the axial arm 44a is substantially equal to the thickness of the radial arm 44b that continues on from it, so that this radial arm 44b has an inner face, oriented towards the opening 55, that is axially in line with the corresponding lateral face 53 or 54.

It will be noted that, in the circumferential direction, the length of the locking protrusion 56, that is the distance between its ends 56a and 56b, is greater than the gap between the ends 32a and 32b of the holder 32. If the gap between the ends 32a and 32b increases, for example in order to adapt to the diameter of the rotary shaft 14, the ends 32a and 32b thus slide on the locking protrusion 56 and remain bearing axially against the protrusion 56.

According to other features, the tabs 44 are spaced apart from each other in the circumferential direction, preferably evenly spaced apart. Alternatively, uneven circumferential spacing could be provided. The number of first tabs 441 is equal to the number of second tabs 442. In the exemplary embodiment illustrated, there are six tabs 44: three first tabs 441 and three second tabs 442.

Alternatively, a greater or lesser number of tabs 44 may be provided. For example, only two tabs 44 may be provided or at least four tabs 44. Preferably, the total number of tabs 44 is at least equal to two.

Furthermore, the tabs 44 preferably extend on only one circumferential portion of the radial portion 42. In other words, the radial portion 42 has another circumferential portion without tabs 44, on which other portion entirely comprises the locking protrusion 56.

The mounting plate 40 of the brush also comprises a plurality of centering lugs 46 extending from the radial portion 42 and spaced apart from each other in the circumferential direction. A notch 48 (FIGS. 2 to 4) is formed on the radial portion 42 between each pair of immediately successive lugs 46. The lugs 46 are formed by cutting and bending the radial portion 42.

Each centering lug 46 extends axially from the radial portion 42. The lugs 46 extend obliquely from a large diameter edge of the radial portion 42; that is, from the outer annular edge 52 of the radial portion 42. The lugs 46 are partially offset radially outwardly relative to the tabs 44. Preferably, the lugs 46 are formed identical to each other. The lugs 46 define the outer diameter of the mounting plate 40. Preferably, each lug 46 extends obliquely. Alternatively, the lugs 46 could extend entirely axially. Each lug 46 is in the form of a cylinder portion (i.e., a partial cylinder). The orifice of each lug 46 is radially spaced apart from the holder 32 by a non-zero radial distance. The outer surfaces of the lugs 46 collectively define the outer diameter of the mounting plate 40. The lugs 46 make it possible to center the mounting plate after mounting in the orifice or bore of the housing 12 of the associated electric motor 10.

As can be seen clearly in FIGS. 2 to 4, the lugs 46 are spaced apart from each other in the circumferential direction, preferably evenly. Alternatively, the lugs 46 may be spaced unevenly circumferentially spaced apart. Each tab 44 is situated in the circumferential direction between two immediately successive lugs 46; specifically, each tab 44 is spaced apart in the circumferential direction from the two immediately adjacent lugs 46. Preferably, each lug 46 has a larger circumferential dimension than a circumferential dimension of each tab 44.

The mounting plate 40 is preferably made by cutting and stamping. The mounting plate 40 is made from a conductive material, such as for example aluminum, stainless steel, bronze, copper or another material. Alternatively, the mounting plate 40 can be made from an electrically non-conductive material with a conductive coating or a conductive paint. Here, the mounting plate is made in one piece.

During the operation of the electric machine, the electrical charges that accumulate on the shaft 14 are dissipated towards the housing 4 through the conductive fibers 31, the holder 32 of the brush 30, and the mounting plate 40 of the assembly 20.

The helical shape of the brush 30 makes it possible to brush or engage with the outer cylindrical surface 14a of the rotary shaft 14 over a relatively large zone without affecting the instantaneous contact surface between the brush 30, and more specifically the conductive fibers 31, and the shaft 14. The wear of the shaft 14 is thus limited or reduced, while the electrical performance of the brush assembly 20 is preserved. In addition, when the shaft 14 is lubricated with oil, the brush 30 acts like an auger to drain any excess oil and thus limit the friction torque that such excessive oil can cause or generate. The direction of the helical winding about which the holder 32 and the brush 30 are wound can in particular be adapted to the direction of rotation of the shaft 14 in order to drain the oil in a predetermined direction, for example to move it away from the roller bearing 16 in the vicinity of which the brush assembly 20 is mounted.

The assembly 20 is mounted so that the centering lugs 46 of the mounting plate 40 are situated axially on the same side as the bearing 16.

In the exemplary embodiment illustrated, the mounting plate 40 of the grounding brush assembly 20 comprises a plurality of centering lugs 46. Alternatively, the lugs could be replaced by a single annular flange forming an annular centering portion.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly comprising:
a grounding brush including a holder and a plurality of conductive fibers mounted within the holder; and
a brush mounting plate rigidly connected to the brush holder;
wherein the holder and the conductive fibers of the brush each extend helically, the holder having a first end and a second end opposite to the first end, the first and second ends defining a circumferential dimension of the holder, the first end and the second end being axially offset relative to each other.

2. The assembly according to claim 1, wherein the mounting plate includes a radial portion and at least one centering portion that at least axially extends from the radial portion, the at least one centering portion being offset radially outwardly relative to the holder and provided with an outer face defining the outer diameter of the mounting plate, the radial portion of the mounting plate defining a through-opening, the holder of the brush extending through the through-opening.

3. The assembly according to claim 2, wherein the radial portion of the mounting plate is annular and extends radially between an inner edge defining the opening and an outer edge from which the centering portion extends, the holder of the brush at least partially bearing radially against the inner edge.

4. The assembly according to claim 2, wherein the radial portion of the mounting plate is provided with a first lateral face and a second lateral face on an opposite side from the first lateral face, the first and second later faces defining a thickness of the radial portion, the first end of the holder of the brush bearing axially against the first lateral face or the second end of the holder of the brush bearing axially against the second lateral face.

5. The assembly according to claim 4, wherein the radial portion of the mounting plate locally has a locking protrusion extending radially inside of the opening, the first end of the holder and/or the second end of the holder bearing axially against the locking protrusion.

6. The assembly according to claim 5, wherein a circumferential length of the protrusion of the radial portion of the mounting plate is greater than a gap between the first end and the second end of the holder of the brush.

7. The assembly according to claim 1, wherein the mounting plate includes a plurality of retaining members for retaining the holder of the brush.

8. The assembly according to claim 7, wherein some of the retaining members are formed on a first lateral face of the radial portion of the mounting plate and a remainder of the retaining members are formed on a second lateral face of the radial portion of the mounting plate.

9. The assembly according to claim 7, wherein the retaining members include centering tabs, each tab having an axial arm and a radial arm extending radially inwardly from the axial arm, the holder bearing axially against at least some of the radial arms of the centering tabs and bearing radially against at least some of the axial arms of the centering tabs.

10. An electric motor comprising:
a housing;
a shaft;
at least one bearing mounted radially between the housing and the shaft; and
at least one grounding brush assembly according to claim 1, mounted radially between the housing and the shaft, the conductive fibers of the brush of the assembly being in contact with the shaft.
